(19) United States
(12) Patent Application Publication
(10) Pub. No.: US 2018/0287435 A1
(43) Pub. Date: Oct. 4, 2018

(54) Coil Topologies for Wireless Power Transfer

(71) Applicant: Integrated Device Technology, Inc., San Jose, CA (US)

(72) Inventors: David WILSON, Soquel, CA (US); Gustavo MEHAS, Mercer Island, WA (US)

(21) Appl. No.: 15/944,508

(22) Filed: Apr. 3, 2018

Related U.S. Application Data
(60) Provisional application No. 62/481,026, filed on Apr. 3, 2017.

(51) Int. Cl. H02J 50/90; H02J 7/02; H02J 50/80

(52) U.S. Cl. CPC H02J 50/90; H02J 50/12; H02J 50/80; H02J 7/025

(57) ABSTRACT

A wireless power transmitter is presented. The wireless power transmitter includes a plurality of coils, each of the plurality of coils arranged to cover an area within transmit area; and a transmitter circuit coupled to energize each of the plurality of coils, the transmitter circuit energizing one or more of the plurality of coils to efficiently transfer power to a receiver.

### RELATED CASES

This disclosure claims priority to U.S. Provisional Application 62/481,026, filed on Apr. 3, 2017, which is herein incorporated by reference in its entirety.

### TECHNICAL FIELD

Embodiments of the present invention are related to wireless power systems and, specifically, to coil topologies used in antennas of wireless power transmitters.

### DISCUSSION OF RELATED ART

With the proliferation of wireless devices, wireless power has also become very popular. Charging stations, which do not require the user to carry a bundle of cables, are becoming available in a number of places. Furthermore, portable devices that allow for wireless charging are becoming more common. Wireless charging can be a convenient and fast method of charging mobile devices, as well as electric vehicles or other such devices.

Power efficiency is a consideration in wireless transfer. A wireless transmitter can be powered by any power source, for example a standard A/C outlet, separate batteries, or other sources. The transmitter converts the input power to a time varying magnetic field, usually by driving a transmitter coil or other antenna. A receiver includes a similar receive coil that can receive the time-varying magnetic field when the receive coil is placed proximate to the transmitter coil to receive the power transmitted in the time-varying magnetic field. With conventional configurations, a square or circular coil is provided to produce the time varying magnetic field. However, in many cases the transfer of power from the transmitter coil to the receive coil can be highly inefficient, especially due to poor placement of the receiver coil relative to the transmit coil.

Therefore, there is a need to find better ways of providing the magnetic fields to a receiver for higher efficiency power transfer.

### SUMMARY

In accordance with some embodiments of the present invention, a wireless power transmitter is presented. The wireless power transmitter includes a plurality of coils, each of the plurality of coils arranged to cover an area within transmit area; and a transmitter circuit coupled to energize each of the plurality of coils, the transmitter circuit energizing one or more of the plurality of coils to efficiently transfer power to a receiver.

These and other embodiments are further discussed below with respect to the following figures.

### BRIEF DESCRIPTION OF THE DRAWINGS

FIG. 1 illustrates a wireless power transmission system.

FIG. 2 illustrates the transmitter coil positioned on a printed circuit board of a transmitter.

FIG. 3 illustrates the magnetic field lines around a conventional circular coil.

FIG. 4 illustrates a transmitter with multiple transmit coils according to some embodiments.

FIG. 5A through 5F illustrate various coil topologies according to some embodiments.

FIG. 6 illustrates an example topology according to some embodiments.

FIG. 7 illustrates a cross section of an example topology as illustrated in FIG. 6

FIGS. 8A and 8B illustrate a system for driving coil topologies such as those illustrated in FIGS. 5A through 5F and FIG. 6.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

The figures are illustrative only and relative sizes of elements in the figures have no significance. For example, although in FIG. 2 receiver coil 108 is illustrated as smaller than transmitter coil 106, receiver coil 108 may be the same size as transmitter coil 106 or may be smaller, or larger depending on particular systems.

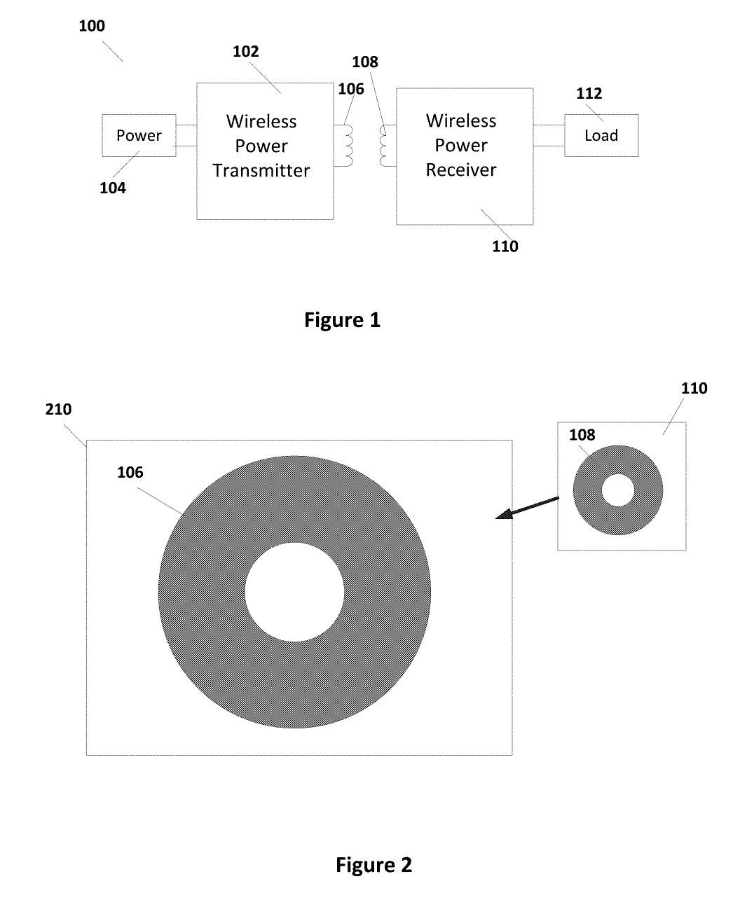

FIG. 1 illustrates a system 100 for wireless transfer of power. As illustrated in FIG. 1, a wireless power transmitter 102 drives a coil 106 to produce a time-varying magnetic field. A power supply 104 provides power to wireless power transmitter 102. Power supply 104 can be, for example, a battery based supply or may be powered by alternating current for example 120V at 60 Hz. Wireless power transmitter 102 drives coil 106 at, typically, a range of frequencies, typically according to one of the wireless power standards. The principles of FIG. 1 can be applicable to any frequency where it is practical to transfer power and/or information by means of magnetic coils irrespective of any standard that may exist.

There are multiple standards for wireless transmission of power, including the Alliance for Wireless Power (A4WP) standard and the Wireless Power Consortium standard, the Qi Standard. Under the A4WP standard, for example, up to 50 watts of power can be inductively transmitted to multiple charging devices in the vicinity of coil 106 at a power transmission frequency of around 6.78 MHz. Under the Wireless Power Consortium, the Qi specification, a resonant inductive coupling system is utilized to charge a single device at the resonance frequency of the device. In the Qi standard, coil 108 is placed in close proximity with coil 106 while in the A4WP standard, coil 108 is placed near coil 106 along with other coils that belong to other charging devices. FIG. 1 depicts a generalized wireless power system 100 that operates under any of these standards. In Europe, the switching frequency has been limited to 148 kHz.

As is further illustrated in FIG. 1, the magnetic field produced by coil 106 induces a current in coil 108, which results in power being received in a receiver 110. Receiver 110 receives the power from coil 108 and provides power to a load 112, which may be a battery charger and/or other components of a mobile device. Receiver 110 typically includes rectification to convert the received AC power to DC power for load 112.

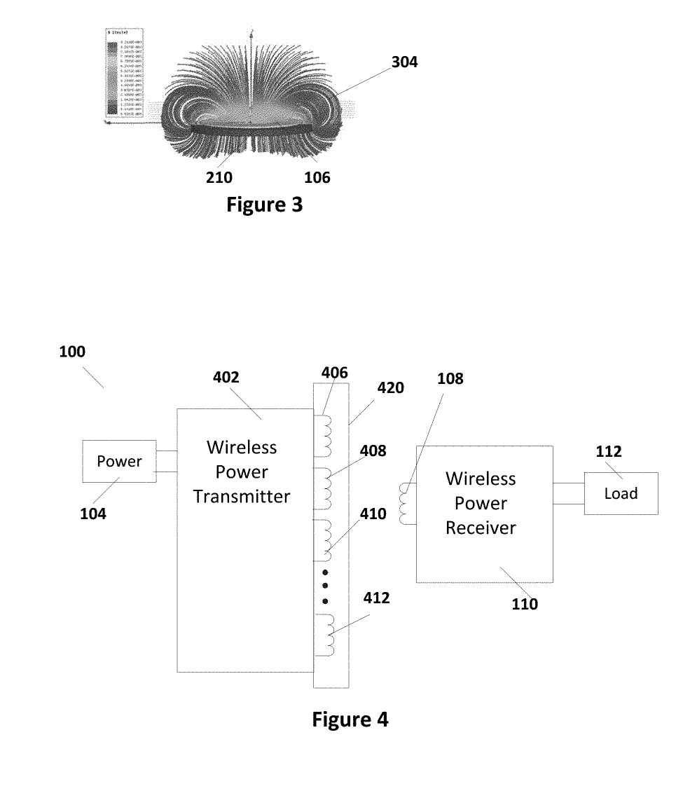

FIG. 2 illustrates a transmit coil 106 mounted on a substrate 210. Further, receiver coil 108 mounted in receiver 110 is shown being positioned proximate to transmit coil 106. In the configuration illustrated in FIG. 2, the positioning of receiver coil 108 relative to transmit coil 106 can greatly affect the efficiency of wireless power transfer. FIG. 3 illustrates the magnetic field lines 304 produced by transmitter coil 106 as illustrated in FIG. 2, which is a circular coil. As illustrated in FIG. 3, the receive coil should be positioned closely to align with the center of transmit coil 106 with the center of receive coil 108 in order to maximize the flux (and therefore the power transfer) between transmitter coil 106 and receiver coil 108.

Some embodiments of the present invention include a transmitter that engages multiple coils in such a way as to efficiently transfer power to a receiver coil placed above the multiple coils. Such an arrangement is illustrated in FIG. 4. The wireless power useful working area over the transmitter coil can be improved by replacing transmitter coil 106 with multiple coils 420 as illustrated in FIG. 4. Figure illustrates a wireless power transmitter circuit 402 that drives one or more of a plurality of coils in multiple coils 420. Although coils 406, 408, 410, and 412 are illustrated in FIG. 4, multiple coils 420 can be any number of coils two or greater. Further, in some embodiments transmitter 402 can power each of the multiple coils in multiple coils 420 in response to receiver coil 108 placement in order to optimize power transmission to the receiver. Rectangular or square arrays of overlapping coils yield square or rectangular working areas. However, many products are round or ovoid so that different coil topologies can improve the working areas for such rounded forms. In general, one or more of the plurality of coils in multiple coils 420 can be driven to produce magnetic field strengths according to the position of receiver coil 108 relative to the multiple coils 420, as is further illustrated in FIG. 4.

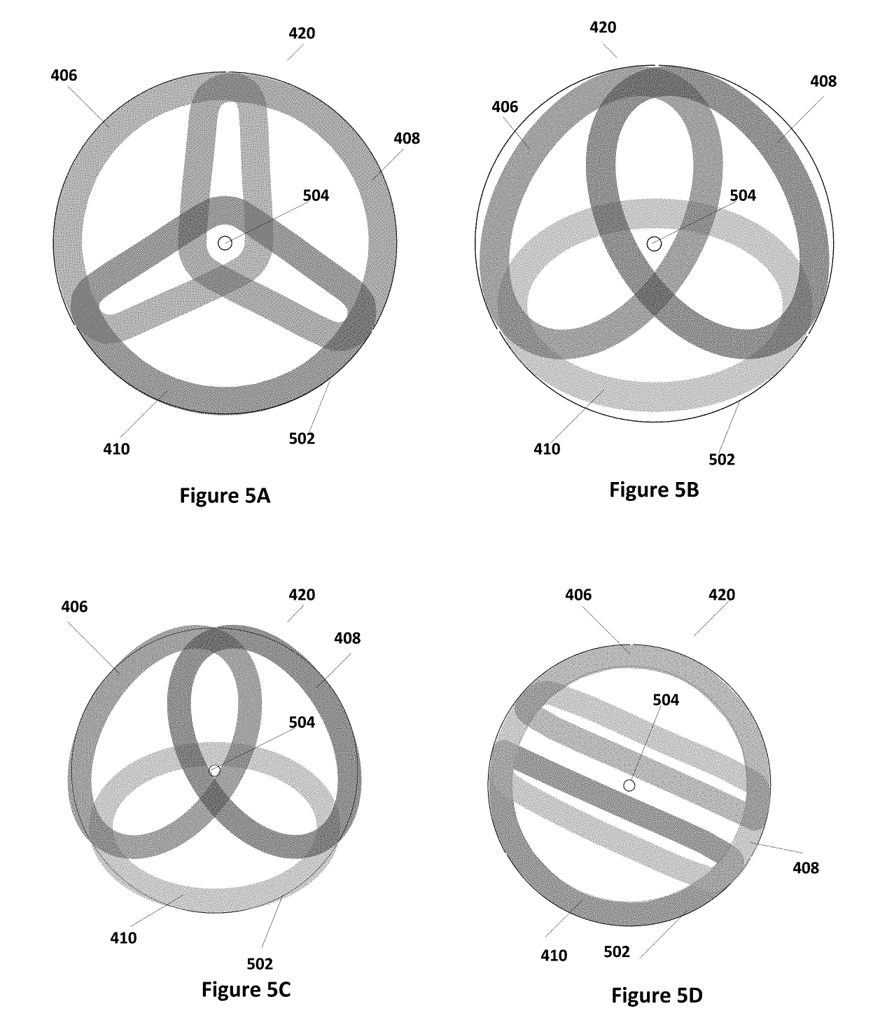

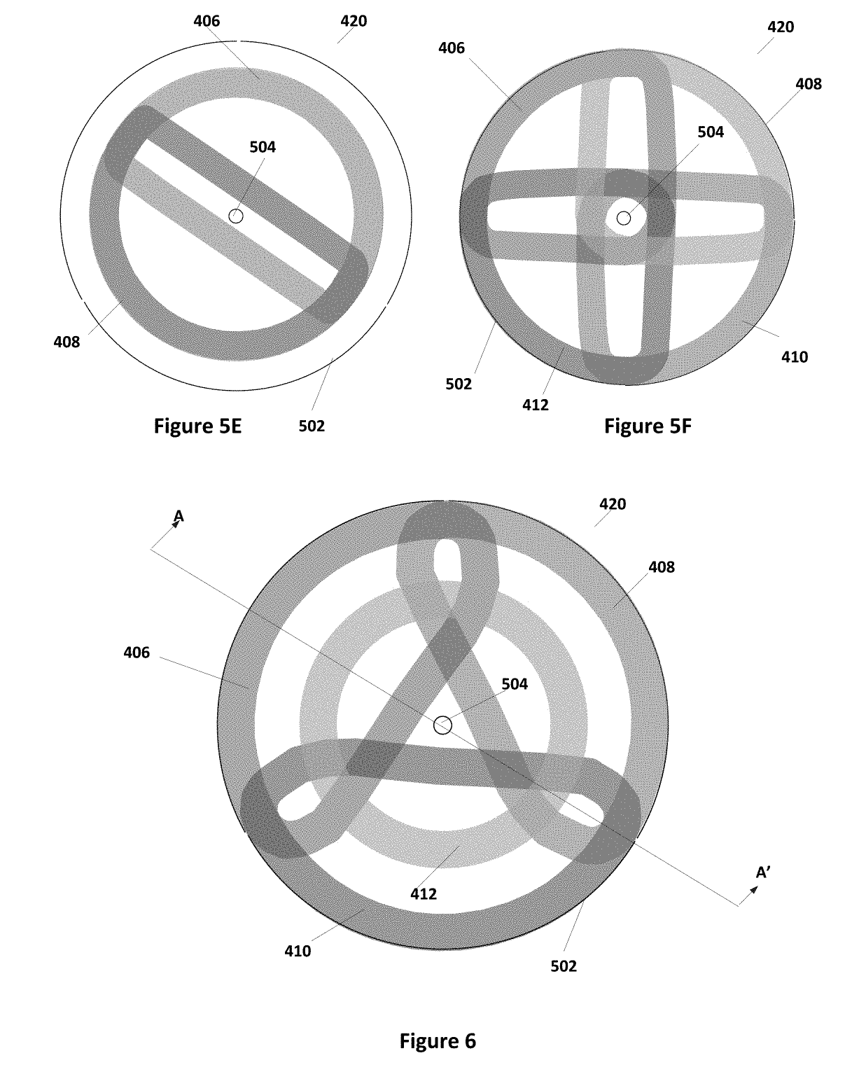

FIGS. 5A through 5E illustrate various multiple-coil topologies that can be used in multiple coils 420 coupled to wireless power transmitter 402. FIGS. 5A through 5E illustrate some topologies that may improve optimization and provide wireless power coverage over a circular area 502. These examples are not exhaustive of all possible multiple-coil topologies that can be used to optimize wireless power transfer between multiple coils 420 and receive coil 108.

In some cases, a rounded form for each coil can be used. Although such is more manufacturable, that topology may also result in poor coverage and yield large areas of redundant coverage. Redundant coverage typically comes at a cost of lower efficiency and less overall useful area for the coil investment.

FIG. 5A illustrates a topology where coils 406, 408, and 410 are pie-piece shaped coils arranged within a circular area defined by circle area 502 where each of coils 406, 408, and 430 include a center portion 504. The topology provides good symmetry and overlap of coverage areas without excess redundancy. As is further illustrated, the maximum coil stack (i.e. the number of coils placed on top of each other) to produce the topology of FIG. 5A is two. It is generally preferable that all coils have similar coupling to a magnetic shield back material if one is used, so overlay stacking coils can be problematic.

FIG. 5B illustrates a topology of multiple coils 420 where coils 406, 408, and 410 are generally oval shapes arranged within a circular area 502 such that the intersection of each of the coils 406, 408, and 410 include a center portion 504. The topology of FIG. 5B exhibits good symmetry. However, the regular shape of coils 406, 408, and 410 may result in excessive overlap of coverage areas, leading to less optimization of results. There are still a maximum coil stack of two coils (i.e. no more than two coils need to be stacked on top of each other to achieve the topology). As discussed above, it is generally preferable that each of coils 406, 408, and 410 have similar coupling to any magnetic “shield” backing material, if that is used.

FIG. 5C illustrates a topology of multiple coils 420 that is similar to that illustrated in FIG. 5B. Coils 406, 408, and 410 are again generally oval shapes that are arranged in circular area 502 to better overlap with the periphery of circular area 502 and where center region 504 formed by the intersection of coils 406, 408, and 410 is smaller than that illustrated in FIG. 5B. Again, the topology of FIG. 5C has good symmetry. The regular shape of coils 406, 408, and 410 may again result in excessive overlap of coverage areas. There is still a maximum stacking of two coils in forming the topology of FIG. 5C.

FIG. 5D illustrates another topology of multiple coils 420. As illustrated in FIG. 5D, coils 406 and 410 are D-shaped coils with rounded edges substantially aligned with the edge of circular region 502. Coils 406 and 410 do not overlap so that center region 504 is not covered by either of coils 406 and 410. Coil 408 is a race-track shaped coil (rounded ends with straight sides) where the straight sides are parallel with the straight sides of the D-shaped coils 406 and 410. Coil 408 surrounds enter region 504 and overlaps D-shaped coils 406 and 410. The rounded parts of coil 408 and D-shaped coils 406 and 410 fall along the edge of circular region 502. The topology illustrated in FIG. 5D can have a good overlap of coverage areas without excess redundancy. There is still a maximum stacking of two coils in forming the topology of FIG. 5D. However, coil 408, the center coil, is not the same form as is coils 406 and 410. It may be desirable that each coil in multiple coils 420 have the same area of coverage. Again it is desirable that each of the coils in multiple coils 420 have similar coupling to any magnetic “shield” back material if that material is present.

FIG. 5E illustrates another topology of multiple coils 420. As illustrated in FIG. 5E, multiple coils 420 includes two D-shaped coils, coils 406 and 408, where the flat sides are parallel. Coils 406 and 408 overlap so that center region 504 is included in the intersection between coils 406 and 408. The topology of FIG. 5E illustrates good symmetry and overlap of coverage areas without excess redundancy. In some embodiments, the area covered by coils 406 and 408 is smaller than the area indicated by area edge 502. However, the total cost and complexity is lower. The topology illustrated in FIG. 5E has a two-coil stack.

FIG. 5F illustrates another topology of multiple coils 420. As illustrated in FIG. 5F, the topology is formed by overlapping pie-piece shaped coils 406, 408, 410, and 412. The large rounded portions of coils 406, 408, 410, and 412 align with area edge 502 while the point portions of coils 406, 408, 410, 412 intersect to include center region 504. There is good symmetry and overlap coverage areas without excess redundancy. However, this topology has a maximum coil stack of three coils. As stated above, it is preferable that all coils have similar coupling to magnetic “shield” backing material if present.

FIG. 6 illustrates another topology of multiple coils 420. As illustrated in FIG. 6, the topology is formed by overlapping pie-piece shaped coils 406, 408 and 410. Coils 406, 408 and 410 are arranged in overlapping fashion to cover area edge 502 while not covering center region 504. A fourth circular coil 412 is centered on center region 504 and overlaps coils 406, 408, and 410. The topology of FIG. 6 may have better performance because of the lower service area required of each coil. However, it is again less desirable that center coil 412 is not the same form as coils 406, 408, and 410. Generally, the goals includes that the service area of each coil in multiple coils 420 is the same. The topology illustrated in FIG. 6 has a maximum coil stack of two, which allows a better possibility for similar coupling between each of coils 406, 408, 410, and 412 with any magnetic shield backing material used.

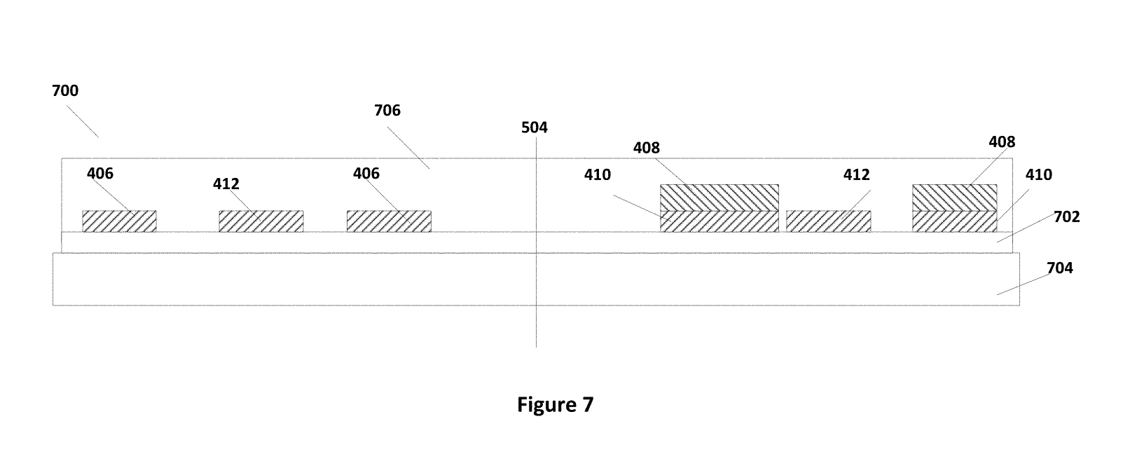

FIG. 7 illustrate a cross-section of a coil topology such as that illustrated in FIGS. 5A through 5F or FIG. 6. In the particular example illustrated in FIG. 7, the cross-section A-A′ indicated in FIG. 6 is illustrated. As shown in FIG. 7, a magnetic shield backing material 702 can be formed on a printed circuit board (PCB) 704. Coils 406, 408, 410, and 412 can be formed over PCB 704 and material 702. In some embodiments, other layers may be formed. As is further illustrated, the illustrated segments of coil 408 are formed over coil 410. In some embodiments, a protective layer 706 is formed over coils 406, 408, 410, and 412. Transmitter circuits that driver coils 406, 408, 410, and 412 may also be formed on PCB 704, either in another portion of PCB 704 or on the back side of PCB 704.

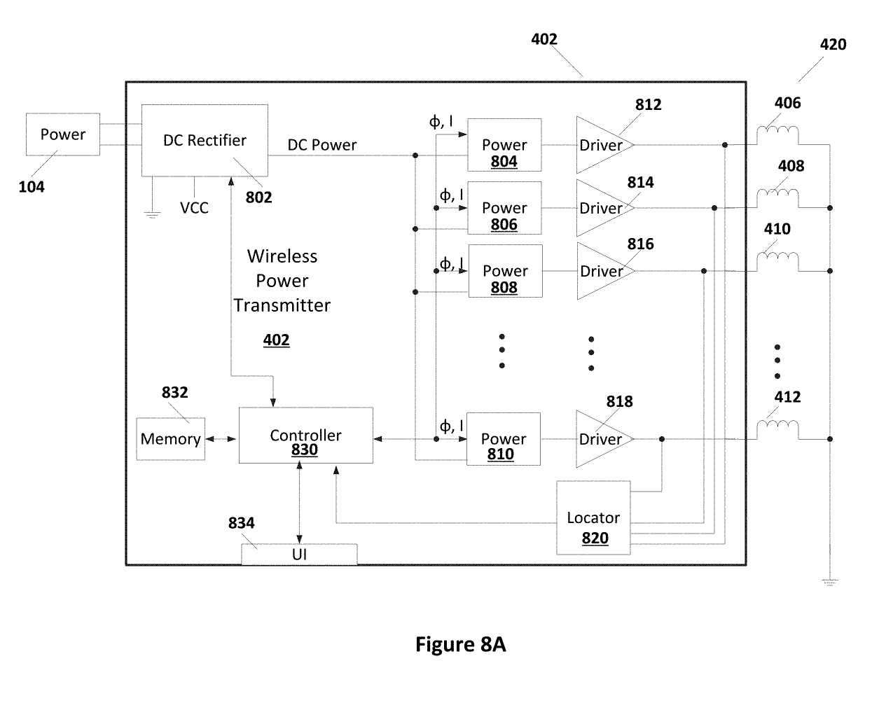

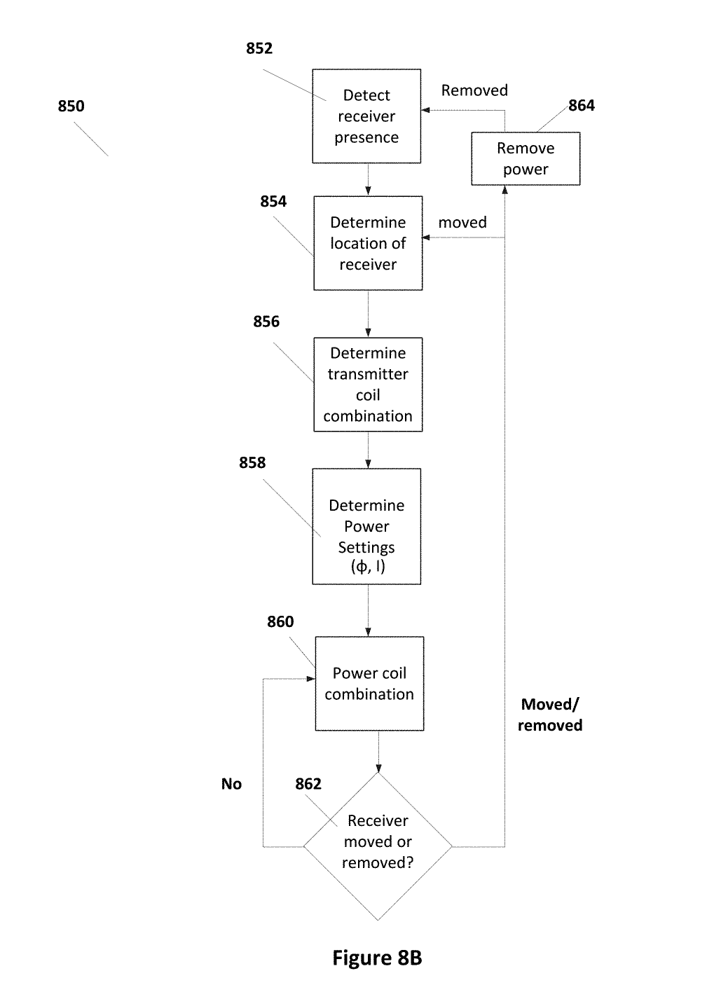

FIG. 8A illustrates an example of transmitter 402 according to some embodiments of the present invention. As illustrated in FIG. 8A, transmitter 402 receivers power from power supply 104 and drives multiple coils 420 in order to provide wireless power to a receiver 110 as illustrated in FIG. 4. As illustrated in FIG. 8A, a rectifier circuit 802 receives power from power source 104. Power source 104 can be an AC source or a DC source. Rectifier 802 provides DC power for transmitter 402, including providing DC power to power units 804, 806, 808, and 810. Power units 804, 806, 808, and 810 each provide the alternating current to a driver 812, 814, 816, and 818, respectively. Drivers 812, 814, 816, and 818 drive transmit coils 406, 408, 410, and 412, respectively. In some embodiments, there is a power unit and driver pair for each individual coil in the multiple coils 420, although only a few examples are provided here.

Rectifier 820 and power units 804, 806, 808, and 810 are controlled by a controller 830. Controller 830, for example, can include one or more processors or microcontrollers and is configured to monitor the output power of the multiple coils 420 and provide control signals to power units 804, 806, 808, and 810 and, in some cases, to rectifier 802.

As is illustrated in the particular example of FIG. 8A, controller 830 is coupled to memory 832. Memory 832 can be any combination of volatile and nonvolatile memory capable of holding data and programming that can be executed by processor in controller 830. Further, controller 830 may be coupled to a user-interface 834, which may be a data port to which a separate computer system can be coupled. User interface 834 may also include video screens, data input devices, touch screens, or other devices that allow user input.

As is further illustrated in FIG. 8A, a locator 820 can be coupled to receive signals across each of transmit coils 406, 408, 410, and 412. Receive coil 108 can be located in one of multiple ways, either by monitoring the loads from coils 406, 408, 410, and 412 or by a communications, for example through back-channel modulation, from receiver 110. In some embodiments, a separate communications channel can be provided between receiver 110 and transmitter 402 through locator 820. Locator 820 can include analog-to-digital converters and other electronics in order to provide locating signals to controller 830 from which the location of receiver 110 can be calculated. In some embodiments, locator 820 can determine the location and the orientation of coil 108 of receiver 110.

In response to the determined location of coil 108 of receiver 110, controller 830 can provide signals control the power signal outputs form power units 804, 806, 808, and 810. The time-varying current I and the phase ϕ of the time-varying current relative to other activated transmit coils can be provided by controller 830 to control the output time-varying electromagnetic field emitted from the collection of coils 420. Each of the multiple coils 406, 408, 410, and 412 can be controlled separately in order to best optimize the wireless power transfer to receiver 110.

As discussed above, we can discuss the topology of FIG. 6 as an example coil configuration, but understanding that the topologies of any of FIGS. 5A through 5F or other topologies may be used. As discussed above, transmitter 402 can activate one or more of the coils in multiple coils 420 at any given time by providing phase and current control signals to the appropriate ones of power units 804, 806, 808, and 810. However, in some coil topologies, low efficiency regions can be developed at the transitions between individual coils. This practice can further cause low efficiency operation when sliding a receiver coil 108 from the area of one of multiple coils 420 to the area of another one of the multiple coils 420. Additionally, large heights (Z distances) above the area of multiple coils 420 can require large currents through the energized coil of multiple coils 420. Additionally, off-axis placement of receiver coil 108 can also result in large transmit currents through individual coils and low efficiencies. In some embodiments, controller 830 can supply phase and current instructions to the appropriate ones of power units 804, 806, 808, and 810 to efficiently transfer power to a receiver 110 placed in vicinity of multiple coils 420.

In some embodiments, controller 830 may activate multiple ones of the coils in multiple coils 420. For example, in FIG. 6 energizing both coils 412 and 406 provides a better way to use multiple coils to transfer power to a receiver located near those coils than to use only a single one of them. In some embodiments, transmitter 402 can track the position of receiver 110 and, as receiver 110 moves across multiple coils 420, controller 830 of transmitter 402 can energize (slowly or quickly if necessary) appropriate ones of coils 406, 408, 410, and 412 to enable continuous power transfer to receiver 110. For example, as receiver 110 traverses from over the area encompassed by coil 412 to the area encompassed by coil 406, for example, controller 830 of transmitter 402 can lower the current I in coil 412 and increase the current I in coil 406 until, eventually, coil 406 is fully engaged and coil 412 is not engaged. As discussed above, the location of receiver 110 can be tracked by locator 820 in transmitter, for example, by using a secondary coil detection method.

Where the receiver 110 is at a high Z distance above the area of multiple coils 420, coils can be energized with opposite currents (e.g. 180 degrees out of phase) to generate a larger field in the Z direction. For example, if receiver 110 is at a large Z distances above coils 412 and 406, coil 406 may be energized with a phase opposite that of coil 412 to enhance the power transfer at greater heights.

In some applications, for example where that surface area of receiver coil 108 is not parallel with the area of transmitter coils (e.g. the receiver coil 108 is tilted at an angle—for example 45 degrees—from the area of multiple coils 420), transmitter 402 can energize multiple ones of coils 420 with different phase angles to maximize the efficiency of the power transfer to receiver 110 by creating an effective flux vector normal (perpendicular) to the receive coil 108 area.

In some embodiments, controller 830 can control coil 406, 408, 410, and 412 to provide for beam forming, which is accomplished by engaging multiple ones of coils 420 with different phases. Beam forming can result in more efficient transfer of power to receiver 110 than does powering single ones of the coils in multiple coils 420. As illustrated in FIG. 3 above, a single transmission coil 106 has a complex field geometry with both perpendicular and parallel components. Although receiver coil 108, once placed above coil 106, alters the field geometry, FIG. 3 illustrates how placement of a neighboring coil can provide useful flux to a primary coil that is providing power to receiver 110.

FIG. 8B illustrates a flow chart for an algorithm 850 that can be executed in controller 830. Instructions for executing algorithm 850 can be stored in memory 832 and can be loaded into memory 832 by controller 830 through user interface 834. In some embodiments, details of algorithm 850 can depend on the coil topology of multiple coils 420. However, algorithm 850 generally describes an algorithm that can be executed to control power to individual coils 406, 408, 410, and 412 of multiple coils 420.

As illustrated in FIG. 8B, algorithm 850 begins in step 852 by detecting the presence of receiver 110 in the vicinity of multiple coils 420. As described above, receiver 110 can be detected by monitoring the response of one or more of the multiple coils 420 in locator 420 or by otherwise receiving a signal from receiver 110 indicating presence.

In step 854, the location of receiver 110 is determined in controller 830 from signals received from locator 420. Again, the locating of receiver 110 can be determined by monitoring the response of various ones of multiple coils 420 or by separate signals received from receiver 110.

In step 856, controller 830 determines which of the multiple coils 420 to activate, which depends on the location of receiver 110. In step 858, the power and phase settings of the activated coils can be determined. In step 860, current and phase data is sent to individual ones of power units 804, 806, 808, and 810 to drive multiple coils 420 accordingly.

The determination of which coils in the topology to drive and at what current and phase can depend on the topology of the multiple coil 420 and the relation with the location of receiver 110. In some situations, one coil is sufficient to efficiently transfer power to receiver 110. In some situations, multiple coils at differing coils and phases can be used to efficiently direct wireless power to receiver 110.

In step 862, controller 830 determines whether the receiver 110 has been removed or has moved. If not, then algorithm 850 returns to step 860 and continues to provide power to multiple coils 420. If receiver 110 has been removed, then algorithm proceeds to step 864 where power can be removed from multiple coils 420. If receiver has moved, then algorithm 854 proceeds to step 854 where the new location of receiver 110 is determined.

The above detailed description is provided to illustrate specific embodiments of the present invention and is not intended to be limiting. Numerous variations and modifications within the scope of the present invention are possible. The present invention is set forth in the following claims.

What is claimed is:

1. A wireless power transmitter, comprising:
a plurality of coils, the plurality of coils having a topology such that each of the plurality of coils are arranged to cover an area within a transmit area; and
a transmitter circuit coupled to selectively energize individual ones of the plurality of coils, the transmitter circuit energizing one or more of the plurality of coils to efficiently transfer power to a receiver depending on the topology of the plurality of coils and a location of the receiver.

2. The transmitter of claim 1, wherein the transmitter circuit comprises:
a rectifier configured to receive power from a power source and supply power;
a plurality of power units coupled to receive supply power;
a plurality of drivers coupled to the plurality of power units, each of the plurality of drivers coupled to provide alternating current to one of the plurality of coils;
a locator configured to provide signals related to a location of a receiver positioned in the vicinity of the plurality of coils; and
a controller coupled to receive signals from the locator and to provide power control signals to the plurality of power units that determine current levels through each of the plurality of coils depending on the topology of the plurality of coils and the location of the receiver.

3. The transmitter of claim 2, wherein the transmitter circuit can determine orientation of the receiver and the controller can provide power signals that depend on the orientation.

4. The transmitter of claim 1, wherein the transmit area is a circular area.

5. The transmitter of claim 4, wherein the plurality of coils includes D-shaped coils arranged to cover the transmit area.

6. The transmitter of claim 4, wherein the plurality of coils includes pie-piece shaped coils.

7. The transmitter of claim 4, wherein the plurality of coils includes a race-track shaped coil.

8. The transmitter of claim 1, wherein the plurality of coils includes an oval shaped coil.

9. The transmitter of claim 1, wherein the plurality of coils includes a circularly shaped coil.

10. The transmitter of claim 1, wherein the topology of the plurality of coils provides for a maximum coil stack of two.

11. The transmitter of claim 2, wherein the controller executes an algorithm comprising:
determining presence of a receiver;
determining location of the receiver;
determining a coil combination depending on the topology of the plurality of coils and the location of the receiver;
determining power settings for each coil in the coil combination; and
powering the coil combination by sending the power control signals to the power units.

12. The transmitter of claim 11, further including:
determining an orientation of the receiver.

13. The transmitter of claim 11, wherein determining power settings includes current settings and phase settings.

14. A method of wireless power transfer, comprising:
determining presence of a receiver relative to a plurality of coils, the plurality coils having a topology such that each of the plurality of coils are arranged to cover an area within a transmit area;
determining location of the receiver relative to the plurality of coils;
determining a coil combination depending on the topology of the plurality of coils and the location of the receiver;
determining power settings for each coil in the coil combination; and
powering the coil combination by sending the power control signals to the power units.

15. The transmitter of claim 14, further including:
determining an orientation of the receiver.

16. The transmitter of claim 14, wherein determining power settings includes current settings and phase settings.
